(19) United States
(12) Patent Application Publication
(10) Pub. No.: US 2005/0076530 A1
(43) Pub. Date: Apr. 14, 2005

(54) Drying cabinet for wet items

(76) Inventor: Terry Lee Kresser, Ft. Myers, FL (US)

Correspondence Address: Terry Lee Kresser, 13307 Broadhurst Loop, Ft. Myers, FL, 33919, US

(21) Appl. No.: 10/684,040

(22) Filed: Oct. 14, 2003

(51) Int. Cl. F26B 19/00

(52) U.S. Cl. 34/91

(57) ABSTRACT

The invention is a drying cabinet for wet items that are dripping. The drying cabinet is installed in a opening of wall and hidden therein when the cabinet is closed. The front plate of the of the cabinet is hinged at its bottom to a brace in the opening of the wall. When the plate is opened into a horizontal position the inner surface of the plate exhibits a drainage tub having upstanding walls. Hinged braces keep the drainage tub in a horizontal position. When in a horizontal position, there are two forward and upstanding corner braces. The upper ends of the corner braces have a first connecting rod located therein and this connecting rod has rigidly attached thereto a multiple of drying bars whose rear ends are again rigidly connected to a second connecting rod. The second connecting rod is removably connected to a brace in the opening of the wall. This arrangement will keep the opened cabinet in a rigid deployment. However, when the second connector rod is removed from the brace in the wall, the drying bar assembly will rotate downwardly against the two upstanding corner braces while the two corner braces will fold into the drainage tub and the cover plate can now rotate upwardly and will close the opening of the cabinet.

### CROSS REFERENCE TO RELATED APPLICATIONS

(none)

### STATEMENT REGARDING FED SPONSORED R & D

(none)

### BACKGROUND OF THE INVENTION

The invention discloses a drying cabinet for wet items such as wet clothing such as bathing suits, wash clothes or mostly small towels. The drying cabinet is in the form of a cabinet which is normally hidden in the wall but can be pulled out to display drying racks.

There are known many known drying racks in the form of drying bars that are hingedly mounted on a wall in a bathroom that will swing about a vertical axis to different positions so that many different items can be accommodated at the same time. If the items to be dried are still wet, they may drip water on the floor which is an undesirable occurrence. Other drying racks appear in the form of a collapsible frame that can be used standing in a bath tub or other surfaces having many horizontal drying rods thereon.

### BRIEF SUMMARY OF THE INVENTION

The invention at hand does away with all of the above named and explained drying implements and creates a clean appearance when it is installed in a bathroom wall or any other environment. The inventive drying cabinet, when not in use, will disappear in a wall and will open up to exhibit a number drying rods and will disappear when the cabinet is closed into the wall. A bottom plate acts as a water drainage collector and hides the drying rods into the wall when not needed. This type of drying cabinet makes up for a neat installation in a bath room wall or any other environment when it is in a closed position with only the bottom surface of the water drainage collector showing.

### BRIEF DESCRIPTION OF THE DRAWINGS

FIG. 1 shows the closed cabinet when installed in a wall;

FIG. 2 Shows the drying cabinet when pulled out of a wall and opened up;

FIG. 3 illustrates some of the stabilizing elements;

FIG. 4 shows a stabilizing spring element in one of the corners of the cabinet.

### DETAILED DESCRIPTION OF THE INVENTION

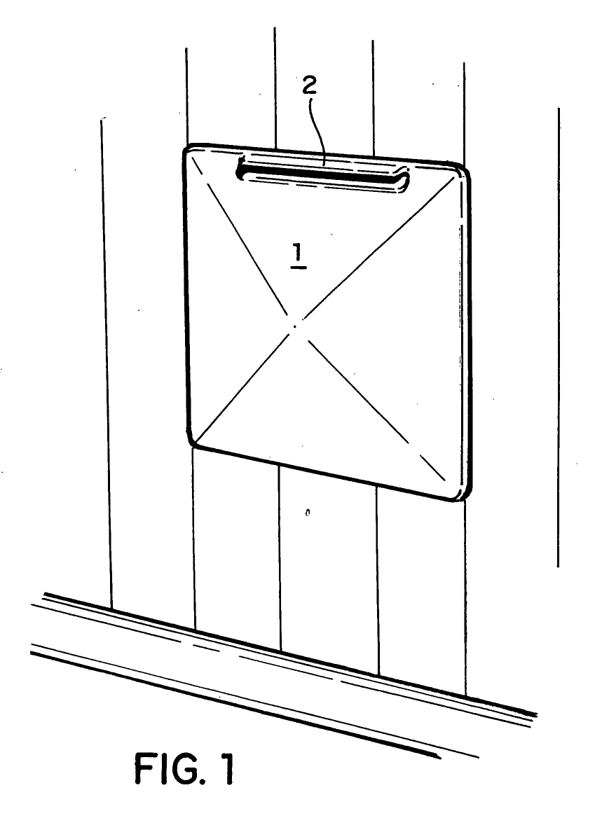

FIG. 1 shows the drying cabinet as it is installed in the wall of a bathroom, for example. The number 1 is the bottom surface of a drainage tub which will be shown in later Figs. The handle 2 is used to pull the drying cabinet down and into position when the drying cabinet is to be used. This illustration is all that can be seen when the drying cabinet is not in use which makes up for a neat and clean appearance.

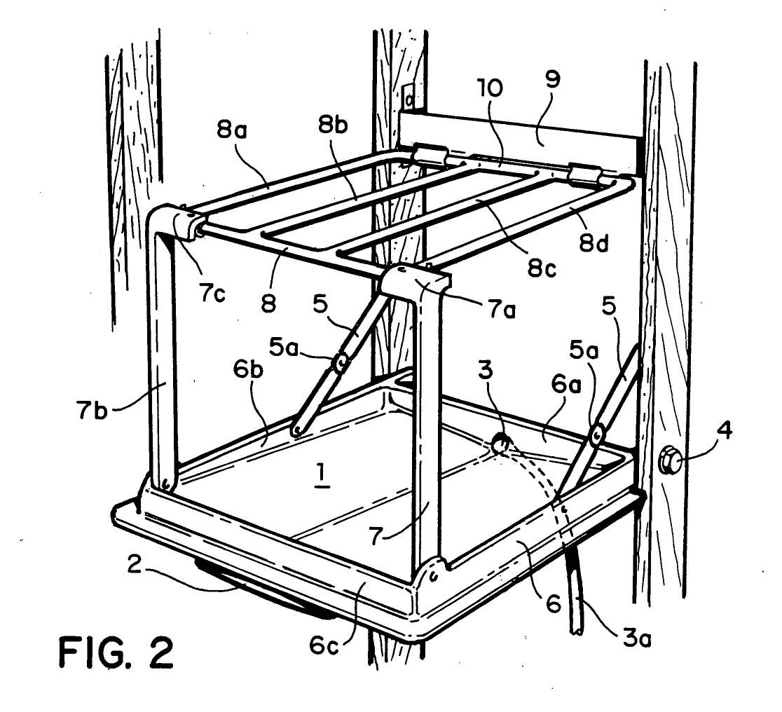

FIG. 2 shows the drying cabinet in its fully deployed position. The drainage tub can not be seen in its fully opened horizontal position. The drainage tub 1 has a rear end bottom drainage hole or opening 3 with a drainage hose leading any dripping water to some other collection point within the wall. The drainage tub 1 is hinged at 4 about which the drainage tub 1 will swing upwardly into its closed position as is shown in FIG. 1. The drainage tub 1 has stabilizing elements 5 in the form of braces that will fold up at the hinge point 5a when the drainage tub is moved to its closed position. The drainage tub on the inside has upstanding walls 6, 6a, 6b, and 6c which together form a water collecting trough. When the drainage tub is in its horizontal position, there are two upstanding corner braces 7 and 7b which are hinged at their bottom edges to the drainage tub. At the top of the corner braces 7 and 7b there are located two angled corner pieces 7a and 7c, respectively, which are connected to each other by a lateral connecting rod 8. From the connecting rod 8 there extend rearwardly parallel drying bars 8a, 8b, 8c and 8c. These drying bars are connected to another lateral connecting rod 10 in the rear. Also in the rear there is located a connector brace 9 between studs in the wall. The lateral connecting rod 10 is removably attached to the connector brace 9. The FIG. 2 illustration shows the drying apparatus in a deployed position. However if it desirable to collapse the drying apparatus into a collapsed or stored position, one merely removes the rear connector rod 10 from the connector brace 9 and the drying bars as a frame will move downwardly against the corner braces 7 and 7b which in turn will move downwardly and collapse into the drainage tub. Thereafter, the drainage tub 1 is moved upwardly into the wall for storage as is shown in FIG. 1.

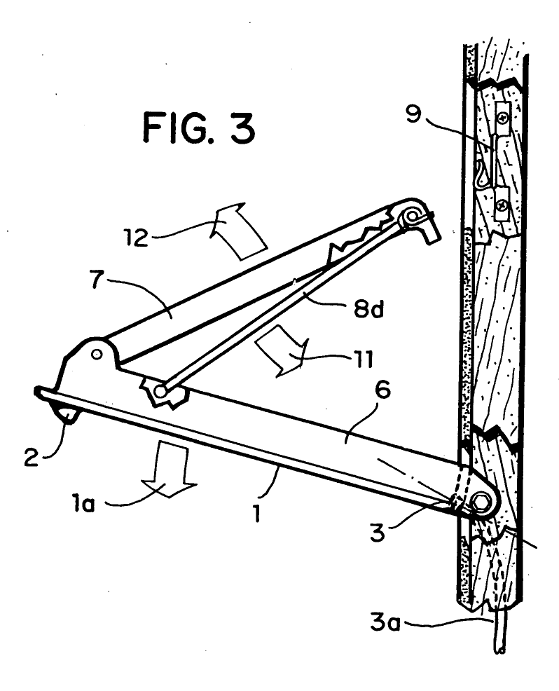

FIG. 3 is a partial view of the movement of the drainage tub on ita way to a downward position. The bottom drainage tub is shown at 1 with the upstanding wall 6. The forward upstanding corner brace is shown at 7 and of the drying rods is shown at 8a. The arrow 11 shows the assembly in a downward movement, while the arrow 12 shows the assembly in an upward movement to a fully assembled position.

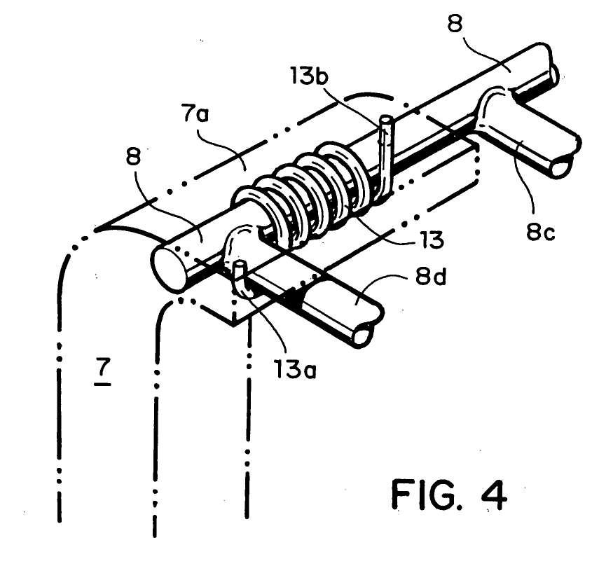

FIG. 4 illustrates a coil spring 13 that is installed at a corner extension 7a of the corner brace 7. The inclusion of a coil spring 13 at this position is to enhance the movement of the various elements relative to each other. The coil spring 13 is wrapped around the bar 8 that connects the various drying bars together. One end 13b of the coil spring 13 is abutted against the corner brace element 7a, while the other end 13a is wrapped around the drying bar 8d. When the drying assembly is to be collapsed and the drying unit with the drying bars is moved downwardly, the coil spring 13 is wound around the bar 8 until fully wound and the assembly is in a stored position such as shown in Fig. When the drainage assembly is to be used again and the drainage tub is released, the tensioned coil spring aids in releasing and lifting the dryer bars almost by themselves.

1. A drying cabinet for wet items adapted to be stored in an opening in a wall and folded out of said wall comprising: a cover plate for said cabinet and said wall, said cover plate has an outer decorative surface and is converted to a drainage tub on its inner surface when said cover plate is folded from said wall into a horizontal position means for holding said converted drainage tub in a horizontal position, means in said drainage tub for collecting water therein and for draining the water away through one of its walls, hinge means at a rear of said drainage tub for hinging said drainage tub relative to said wall, upstanding corner braces located at a front of said drainage tub having means on their lower ends for rotating the same relative to said drainage tub, a first connecting rod connects said upstanding corner braces at upper ends thereof, a multiple of drying bars are rigidly connected to said connecting bar and extending rearwardly toward said wall, a second connecting rod located at a rear of said drainage tub and rigidly connected to rear ends of said drying bars, said second connecting rod is removably connected to a brace in said opening in said wall.

2. The drainage cabinet of claim 1, wherein said means for holding said drainage tub in a horizontal position are hinged folding braces.

3. The drainage cabinet of claim 1 including coil springs each located at the upper ends of each of the corner braces to be tensioned between the corner braces and said first connecting rod when they are moving relative to each other.
